(19) United States
(12) Patent Application Publication
(10) Pub. No.: US 2011/0107925 A1
(43) Pub. Date: May 12, 2011

(54) IMAGE RECORDING APPARATUS AND CONTROLLING METHOD THEREOF

(75) Inventor: Masaaki SHIBUYA, Tokyo (JP)

(73) Assignee: OLYMPUS CORPORATION, Tokyo (JP)

(21) Appl. No.: 12/916,753

(22) Filed: Nov. 1, 2010

(30) Foreign Application Priority Data
Nov. 9, 2009 (JP) 2009-255744

(51) Int. Cl. B41G 7/00

(52) U.S. Cl. 101/26

(57) ABSTRACT

An image recording apparatus for recording an image on a recording medium includes a perforation blade controlling unit for controlling perforation processing on the recording medium on the basis of perforation processing information included in the printing information, a perforation processing unit for perforating the recording medium on the basis of an instruction of the perforation blade controlling unit, and a perforation lateral moving unit for moving the perforation processing unit in a direction orthogonal to a conveyance direction of the recording medium on the basis of an instruction of the perforation blade controlling unit. An image recording apparatus having a perforation processing device that can control ON/OFF of vertical perforation processing and can further control a vertical perforation processing position in a direction orthogonal to the conveyance direction of the recording medium on the basis of an instruction from a higher-level device is provided.

### CROSS REFERENCE TO RELATED APPLICATIONS

This application is based upon and claims the benefit of priority from the prior Japanese Patent Application No. 2009-255744, filed on Nov. 9, 2009, the entire contents of which is incorporated herein by this reference.

### BACKGROUND OF THE INVENTION

1. Field of the Invention

The present invention relates to an image recording apparatus for recording an image on continuous paper and for cutting and perforating the continuous paper after recording the image, and to a controlling method thereof.

2. Description of the Related Art

As an image recording apparatus, for example, an inkjet printer records an image at high speed and with high image quality by jetting ink droplets from a plurality of nozzles of recording heads on a recording medium that is held and conveyed by a conveyance system. Inkjet printers are widely used for office purposes of recording an image on a recording medium (paper), for example, in the form of a cut sheet.

In recent years, inkjet printers have been enabled to improve their throughput by configuring a line head where many recording heads are aligned in a direction orthogonal to a conveyance direction of a recording medium, and inkjet printers have been used for industrial purposes of recording an image on a recording medium (continuous paper) such as roll paper or the like.

A device having a function of performing perforation at a desired position of a recording medium is known as a post-processing mechanism of such image recording apparatuses. As an image recording apparatus having such a configuration, the invention recited in the following Japanese Patent Publication is proposed.

For example, Japanese Patent Publication (Japanese Laid-open Patent Publication No. 2000-061889) proposes a random perforation processing device that can perform vertical perforation and horizontal perforation without suspending the conveyance of a recording medium. Accordingly, this is an invention of reading a mark put on a recording medium, controlling driving timing of a perforation blade on the basis of the mark, and performing perforation processing at a desired position of the recording medium.

Additionally, the invention recited in Japanese Patent Publication (Japanese Laid-open Patent Publication No. 2000-143075) is a perforation processing device that engages a perforation blade with a driving source by using a clutch. This is an invention according to which a user turns on/off the clutch by operating a lever and perforation processing can be performed only if the clutch is in an ON state.

### SUMMARY OF THE INVENTION

To achieve the above described object, an image recording apparatus in one aspect of the present invention is an image recording apparatus for recording an image on a recording medium on the basis of printing information from a higher-level device. The image recording apparatus includes: a perforation blade controlling unit for controlling perforation processing on the recording medium on the basis of perforation processing information included in the printing information; a perforation processing unit for perforating the recording medium on the basis of an instruction of the perforation blade controlling unit; and a perforation lateral moving unit for moving the perforation processing unit in a direction orthogonal to a conveyance direction of the recording medium on the basis of an instruction of the perforation blade controlling unit.

A controlling method of an image recording apparatus in another aspect of the present invention is a controlling method of an image recording apparatus for recording an image on a recording medium on the basis of printing information from a higher-level device. The controlling method includes: a perforation processing step of perforating the recording medium on the basis of an instruction of a perforation blade controlling unit for controlling perforation processing on the recording medium on the basis of perforation processing information included in the printing information; and a perforation lateral moving step of moving the perforation processing step in a direction orthogonal to a conveyance direction of the recording medium on the basis of an instruction of the perforation blade controlling unit.

### BRIEF DESCRIPTION OF THE DRAWINGS

FIG. 1 is a block diagram illustrating an image recording apparatus according to an embodiment;

FIG. 2 is a schematic diagram illustrating a layout of the image recording apparatus according to the embodiment excluding a controlling unit;

FIG. 3 is an explanatory view of a configuration of the vicinity of a perforation blade lateral moving unit in the embodiment;

FIG. 4 is an explanatory view of a concept of a perforation blade lateral move in the embodiment;

FIG. 5 is a flowchart illustrating a main routine in the embodiment;

FIG. 6 is a flowchart illustrating an image recording subroutine in the embodiment;

FIG. 7 is a flowchart illustrating a lateral perforation position control subroutine in the embodiment;

FIG. 8 is a flowchart illustrating a perforation processing control subroutine in the embodiment;

FIG. 9 is a block diagram illustrating an image recording apparatus according to a second embodiment; and

FIG. 10 schematically illustrates a layout of a characteristic portion of the second embodiment.

### DESCRIPTION OF THE PREFERRED EMBODIMENTS

Embodiments according to the present invention are described below with reference to the drawings.

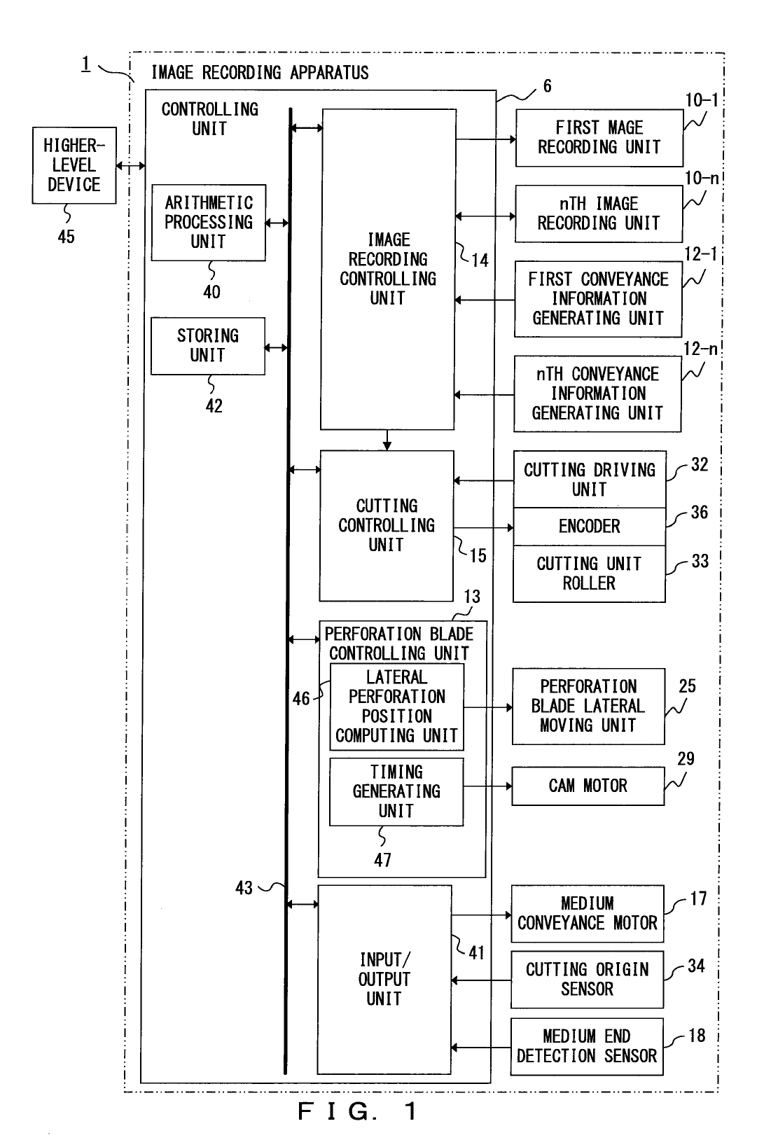

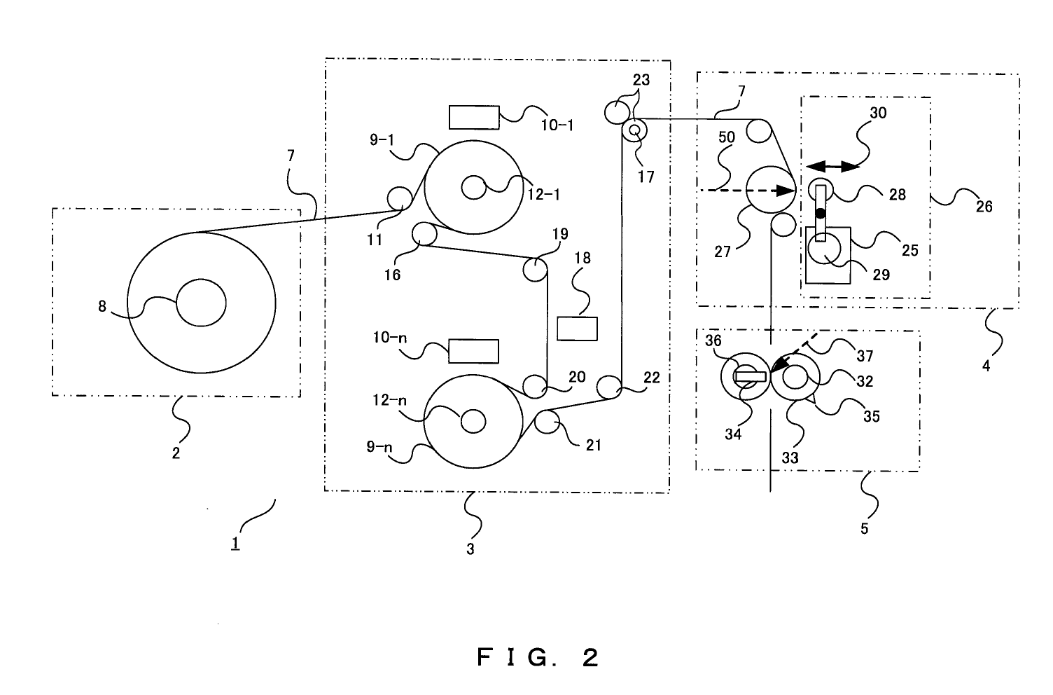

FIG. 1 is a block diagram illustrating a system of an image recording apparatus according to an embodiment. FIG. 2 schematically illustrates a layout of the image recording apparatus according to the embodiment excluding a controlling unit.

The image recording apparatus 1 according to the embodiment includes a medium feeding system 2, an image recording system 3, a perforation processing system 4, and a medium cutting system 5.

The medium feeding system 2 is initially described. The medium feeding system 2 is provided as a winding-off unit for holding a recording medium 7 to be rotatable and for winding off the recording medium 7 to the image recording system 3. In this embodiment, the medium feeding system 2 holds roll paper as the recording medium 7. In the medium feeding system 2, a powder clutch 8 is further arranged to apply a predetermined back tension in a direction reverse to a conveyance direction of the recording medium 7.

The image recording system 3 is described next.

To the image recording system 3, the recording medium 7 conveyed from the medium feeding system 2 is fed. The image recording system 3 winds and holds the recording medium 7 with a first medium supporter 9-1, conveys the recording medium 7 immediately below a first image recording unit 10-1, and executes an image recording process. Thereafter, the image recording system 3 winds and holds the recording medium 7 with an nth medium supporter 9-n, and conveys the recording medium 7 immediately below an nth image recording unit 10-n, which executes an image recording process. After the image recording process, the recording medium 7 is conveyed to the medium cutting system 5 via the perforation processing system 4.

As illustrated in FIG. 2, the image recording system 3 is configured with a recording medium 7 conveying unit composed of a plurality of free rollers, the first medium supporter 9-1 and the nth medium supporter 9-n, and an image recording unit composed of the first image recording unit 10-1 and the nth image recording unit 10-n.

The image recording system 3 according to the embodiment is configured so that both of surfaces of the recording medium 7 can be recorded by two image recording units. The present invention is not limited to this embodiment, and is also applicable to an apparatus for executing a recording process, for example, on one surface of the recording medium 7. The present invention is also applicable to an apparatus including a plurality of image recording units. The above described nth medium supporter 9-n is hereinafter referred to as a second medium supporter 9-n. Similarly, the nth image recording unit 10-n is hereinafter referred to as a second image recording unit 10-n.

A configuration of the first medium supporter 9-1 is described next. The first medium supporter 9-1 of the image recording apparatus 1 according to this embodiment is a drum made of aluminum. The recording medium 7 is wound around the first medium supporter 9-1 with the free rollers 11 and 16 at a winding angle of 330 degrees. The first medium supporter 9-1 is designed to have a perimeter length approximately as three times as the vertical length (420 mm) of an A3 size.

A vertical drag is applied to an outer perimeter of the first medium supporter 9-1 with tensions at winding start and end of the first medium supporter 9-1, and the recording medium 7 is held by the first medium supporter 9-1 according to a frictional coefficient between the first medium supporter 9-1 and the recording medium 7. The first medium supporter 9-1 rotates as a driven drum via the recording medium 7 by driving nip rollers 23 to be described later.

To a rotational axis of the first medium supporter 9-1, a first conveyance information generating unit 12-1 is linked. The rotational axis of the first conveyance information generating unit 12-1 rotates with a rotation of the first medium supporter 9-1, and the first conveyance information generating unit 12-1 outputs a detection pulse corresponding to a rotational position of the first medium supporter 9-1. The detection pulse is provided to the first image recording unit 10-1 and a cutting controlling unit 15 via an image recording controlling unit 14 or the like.

A first recording head not illustrated is caused to jet ink in synchronization with the detection pulse by being driven by a first head driving unit, not illustrated, within the first image recording unit 10-1.

As the first conveyance information generating unit 12-1 of the image recording apparatus 1 according to the embodiment, for example, a rotary encoder that outputs 18000 pulses per rotation is used. The image recording apparatus 1 is designed so that a resolution of the recording medium 7 in the conveyance direction is 300 dpi and one line is recorded per pulse of the first conveyance information generating unit 12-1. Accordingly, a diameter of the first medium supporter 9-1 is obtained as follows.

25.4 inch÷300 dpi×18000 pulses÷circumference ratio π=485 mm.

After the winding end at the first medium supporter 9-1, the recording medium 7 is conveyed to the second medium supporter 9-n via the free roller 19.

A configuration of the second medium supporter 9-n is described next. Also the second medium supporter 9-n has a configuration similar to the first medium supporter 9-1. Namely, the recording medium 7 can be wound around the second medium supporter 9-n at a winding angle of 330 degrees with the free rollers 20 and 21. A vertical drag is applied to an outer perimeter of the second medium supporter 9-n with tensions at winding start and end of the second medium supporter 9-n, and the recording medium 7 is held by the second medium supporter 9-n according to a frictional coefficient between the second medium supporter 9-n and the recording medium 7. The second medium supporter 9-n rotates as a driven drum via the recording medium 7 by driving the nip rollers 23 to be described later.

Similar to the first medium supporter 9-1, an nth conveyance information generating unit 12-n that outputs 18000 pulses is linked to a rotational axis of the second medium supporter 9-n. The nth conveyance information generating unit 12-n outputs a detection pulse corresponding to a rotational position of the second medium supporter 9-n.

The detection pulse is provided to the second image recording unit 10-n via the image recording controlling unit 14. A second recording head not illustrated is caused to jet ink in synchronization with the detection pulse by being driven by a second head driving unit, not illustrated, within the second image recording unit 10-n.

Similar to the above described second image recording unit 10-n, the nth conveyance information generating unit 12-n is hereinafter referred to as a second conveyance information generating unit 12-n.

Incidentally, a medium end detection sensor 18 is provided between the first medium supporter 9-1 and the second medium supporter 9-n. The medium end detection sensor 18 detects positions of both ends of the recording medium 7. The recording medium 7 is continuous paper. Therefore, the position of the recording medium 7, which is orthogonal to its conveyance direction, may sometimes shift by several mm depending on a processed quality of the continuous paper.

The image recording apparatus 1 corrects an image recording position and a perforation processing position on the recording medium 7 by obtaining information about the positions of both ends of the recording medium 7 with the medium end detection sensor 18. The recording medium 7 is sent to the perforation processing system 4 via the free roller 22 after the winding end at the second medium supporter 9-n.

The nip rollers 23 are rollers for conveying the recording medium 7 by being driven by a medium conveyance motor 17 as a driving source. The nip rollers 23 sandwich the recording medium 7, convey the recording medium 7 with a predetermined tension, and send the recording medium 7 to the perforation processing system 4.

The perforation processing system 4 is described next. The perforation processing system 4 includes a perforation blade lateral moving unit 25, a perforation processing unit 26, and an anvil roller 27.

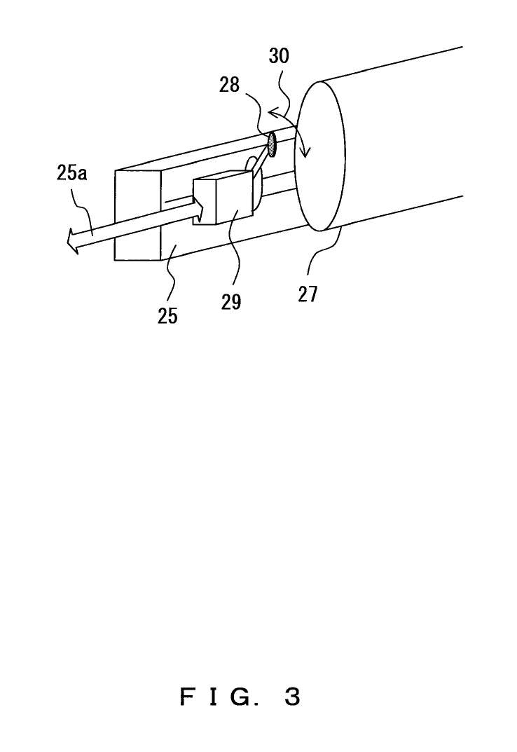

The perforation blade lateral moving unit 25 has a driving source not illustrated, and is driven in a direction orthogonal to the conveyance direction of the recording medium 7. With this driving, the position of the perforation blade 28 can be changed. FIG. 3 is an explanatory view of this configuration. The perforation blade lateral moving unit 25 is configured to be movable in a direction of an arrow 25a illustrated in FIG. 3 by being driven by a driving source not illustrated, so that the position of the perforation blade 28 is moved in the direction orthogonal to the conveyance direction of the recording medium 7.

The perforation processing unit 26 is configured with the perforation blade 28 and a cam motor 29. The perforation processing unit 26 causes the perforation blade 28 to touch or separate from the recording medium 7 by operating the perforation blade 28 in a direction of an arrow 30 with the driving of the cam motor 29. The perforation blade 28 touches the recording medium 7, thereby perforating the recording medium 7.

The anvil roller 27 has both a function as a backup roller when the perforation blade 28 touches the recording medium 7, and a function of sending the recording medium 7 to a downstream.

The medium cutting system 5 is described next. The medium cutting system 5 includes a cutting driving unit 32, a cutting unit roller 33, a cutting origin sensor 34, a blade 35, and an encoder 36.

The cutting unit roller 33 driven by the cutting driving unit 32 is a spiral cutter having one blade 35, and has a perimeter length of 420 mm. By driving the blade 35 at a circumferential speed synchronous with the conveyance speed of the recording medium 7, the recording medium 7 is cut in a length of 420 mm. The image recording apparatus 1 according to this embodiment uses continuous paper having a width of 297 mm as the recording medium 7, and cuts and ejects the continuous paper as A3 size sheets (420×297 mm).

As the cutting driving unit 32, a so-called servo motor is used. The cutting driving unit 32 is driven according to a pulse train instruction issued thereto. The cutting driving unit 32 is not limited to a servo motor, and may be configured with a stepping motor or the like. This embodiment is described by assuming that the continuous paper is cut into pages in a predetermined size.

The cutting origin sensor 34 is arranged to be able to detect that the position of the blade 35 reaches a medium cutting position 37 at which the recording medium 7 is cut, and notifies an arithmetic processing unit 40 of cutting timing of the recording medium 7 by the blade 35. The encoder 36 outputs 10000 pulses per rotation. By counting the number of pulses, a rotational angle of the cutting unit roller 33 can be detected. The arithmetic processing unit 40 learns a positional relationship between the recording medium 7 and the blade 35 on the basis of the rotational angle.

For example, when the number of pulses of the encoder 36 is counted up to 5000 based on the cutting origin sensor 34, it can be determined that the blade 35 stays at a position of 180 degrees relative to the cutting position of the recording medium 7 and the recording medium 7 is to be cut after proceeding by 210 mm.

The controlling unit 6 is described next. As illustrated in FIG. 1, the controlling unit 6 is configured with the above described perforation blade controlling unit 13, image recording controlling unit 14, cutting controlling unit 15, arithmetic processing unit 40, input/output unit 41, and storing unit 42. The arithmetic processing unit 40 is connected to the perforation blade controlling unit 13, the image recording controlling unit 14, the cutting controlling unit 15, the input/output unit 41, and the storing unit 42 via a bus 43. The controlling unit 6 (image recording apparatus 1) is also connected to the higher-level device 45 such as a personal computer (PC) or the like.

The storing unit 42 temporarily stores an operation program of the image recording apparatus 1, recording data from the higher-level device 45, and information such as perforation processing information and the like. The storing unit 42 also stores information such as various adjustment parameters and the like of the image recording apparatus 1.

The image recording controlling unit 14 averages conveyance information of the above described first conveyance information generating unit 12-1 and second conveyance information generating unit 12-n, and outputs the conveyance information of the recording medium 7 to the first image recording unit 10-1, the second image recording unit 10-1, and the cutting controlling unit 15.

The cutting controlling unit 15 issues a driving instruction to the cutting driving unit 32, obtains cutting position information from the encoder 36, and outputs the obtained information to the perforation blade controlling unit 13.

The perforation blade controlling unit 13 includes a lateral perforation position computing unit 46 and a timing generating unit 47. The lateral perforation position computing unit 46 computes the lateral position of perforation on the basis of perforation processing information transmitted from the higher-level device 45, and medium end position information of the medium end detection sensor 18. Namely, the lateral perforation position computing unit 46 computes a position in a direction orthogonal to the medium conveyance direction, and issues a driving instruction to the perforation blade lateral moving unit 25.

The timing generating unit 47 issues a driving instruction to the cam motor 29 for a page to be perforated on the basis of the perforation processing information transmitted from the higher-level device 45.

A perforation processing control that is a characteristic portion of this embodiment is described next. Perforation processing information is transmitted in units of recording pages from the higher-level device 45 to the controlling unit 6 (image recording apparatus 1) along with recording data (image data). The perforation processing information includes information about presence/absence of perforation processing, and perforation processing position information. The perforation processing position information is information for instructing a perforation processing position that represents a distance measured from an end of a recorded image in millimeters.

The arithmetic processing unit 40 determines whether or not to perform perforation processing on a recorded page that reaches the perforation processing system 5 on the basis of the information about presence/absence of perforation processing. If the recorded page is a page for which the perforation processing is to be performed, the arithmetic processing unit 40 issues a computation instruction to the lateral perforation position computing unit 46.

The lateral perforation position computing unit 46 computes a moving position of the perforation blade 28 on the basis of the perforation processing position information and the end position information of the recording medium end detection sensor 18, and issues a driving instruction to the perforation blade lateral moving unit 25. For example, if the perforation processing position information is 197 mm and the end position information is −3 mm from the reference position of the recording medium 7, the lateral perforation position computing unit 46 computes the amount of move of the perforation blade 28 to be 194 mm. Then, the lateral perforation position computing unit 46 issues, to the perforation blade lateral moving unit 25, a driving instruction to move the recording medium 7 from the reference position to the position of 194 mm.

According to this driving instruction, the perforation blade lateral moving unit 25 moves the cam motor 29 in the direction of the arrow 25a illustrated in FIG. 3 by the instructed distance, and drives the cam motor 29. As a result, the perforation blade 28 is driven in the direction of the arrow 30 to perforate the recording medium 7.

The lateral position of perforation is controlled by using the end position information of the recording medium 7 as described above, whereby the lateral position of perforation can be aligned on the recording medium 7 with high precision. The perforation blade lateral moving unit 25 performs a feedback control of a position by using a stepping motor or a server motor. However, the perforation blade lateral moving unit 25 may perform not a feedback control but a control with an open loop.

The lateral position of perforation needs to be moved during the passage of an unperforated page. Accordingly, the moving speed of the perforation blade lateral moving unit 25 is set so that it can move by the width of the recording medium 7 within a passage time of one page. Since the conveyance speed of the recording medium 7 in the image recording apparatus 1 is 555 mm/sec, the moving speed results in 420÷555≈0.75 sec. Therefore, the perforation blade lateral moving unit 25 is configured to be movable by 297 mm within 0.75 sec.

Next, the perforation blade controlling unit 13 computes the timing of performing perforation processing with the timing generating unit 47. The perforation processing is performed relative to the cutting position of the recording medium 7 by the blade 35 of the medium cutting system 5. In the image recording apparatus 1, a perforation position 50 is arranged on a further upstream than the medium cutting position 37 by 315 mm. Accordingly, the recording medium 7 is cut after being touched by the perforation blade 35 and further conveyed by 315 mm. Therefore, the timing generating unit 47 generates the timing when the perforation blade 28 touches the recording medium 7 relative to the timing when a preceding page of the recording medium 7 is cut.

Since the current cutting length of the recording medium 7 in the image recording apparatus 1 is 420 mm, the cutting position of the recording medium 7 and the perforation processing position are aligned by causing the perforation blade 28 to touch the recording medium 7 at timing when the recording medium 7 is conveyed by 105 mm after being cut. When the cutting origin sensor 34 detects that the recording medium 7 has been cut, the timing generating unit 47 starts counting the pulse of the encoder 36. The number of pulses of the encoder 36 at the position where the recording medium 7 is conveyed by 105 mm is 10000×(105÷420)=2500 pulses.

Then, a driving instruction is issued to the perforation processing unit 26 so that the perforation blade 28 is caused to touch the recording medium 7 at the timing when the number of pulses is counted up to 2500. The perforation blade 28 touches the recording medium 7 with a rotation of the cam motor 29. The timing generating unit 47 generates the timing of issuing the driving instruction by taking the rotational time of the cam motor 29 into account.

A similar process is executed also for the termination of the perforation processing, whereby perforation processing can be performed over the entire area of the cut recording medium 7. Moreover, no more perforation processing is performed on pages preceding and succeeding the perforated page of the recording medium 7.

Note that the perforation processing may be performed in a portion of the recording medium 7 by specifying a perforation processing range from the higher-level device 45 without being limited to the entire area of the recording medium 7.

By controlling the perforation processing timing as described above, perforation processing with high precision can be implemented in units of pages.

Additionally, since the image recording apparatus 1 uses continuous paper, the lateral position of the perforation processing cannot be changed on a successive page, and a moving time of one page is needed. Accordingly, if another lateral position instruction for a successive page is received from the higher-level device 45, the arithmetic processing unit 40 instructs the image recording controlling unit 14 to insert a blank page by delaying image recording by one page.

In this way, perforation processing can be performed at a different lateral position also on a successive page. In this case, also the inserted blank page is cut in the same length of 420 mm as that of a page on which an image has been recorded.

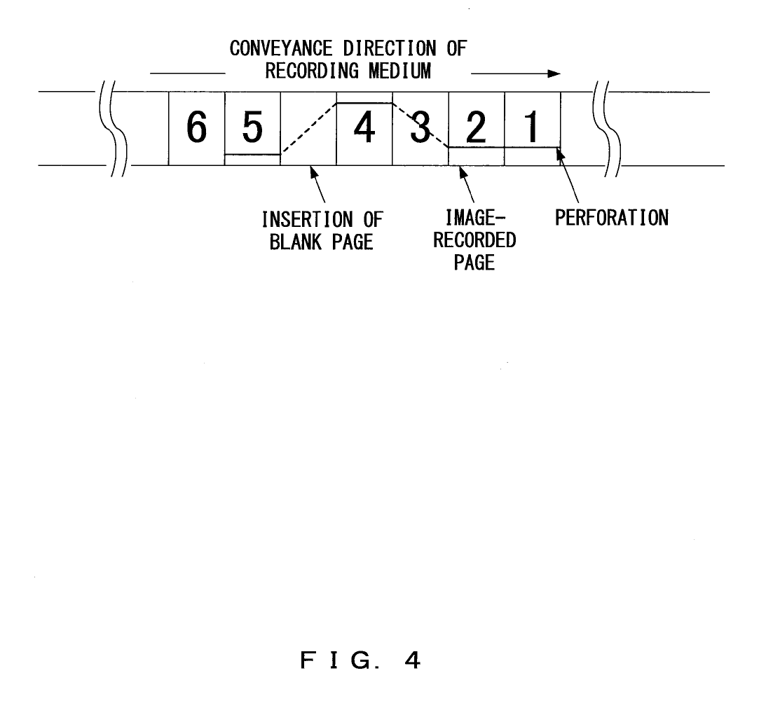

FIG. 4 illustrates a concept of the blank page insertion. In this figure, 1 to 6 respectively indicate pages on which an image is recorded, solid lines indicate perforation positions, and dotted lines indicate perforation blade moving tracks. Here, assume that the pages 1, 2, 4 and 5 are to be perforated. In this case, the perforation processing unit 26 starts perforating the page 1, and also perforates the page 2 at the same lateral position. In this case, there is no need to laterally move the perforation blade 28 between the pages 1 and 2.

The page 3 is not perforated, but the page 4 is perforated at a different lateral position. Accordingly, the perforation blade lateral moving unit 25 moves the perforation blade 28 to the perforation position of the page 4 during the passage of the page 3 the same time the perforation processing unit 26 terminates the perforation at a rear end of the page 2. Then, the perforation processing unit 26 starts perforating at the beginning of the page 4.

Next, the page 5 needs to be perforated at a different lateral position. Accordingly, the arithmetic processing unit 40 instructs the image recording controlling unit 14 to insert a blank page, so that the blank page is inserted. Namely, at a time point when the page 4 has been perforated, the perforation blade lateral moving unit 25 moves the perforation blade 28 to a lateral perforation processing position of the page 5 during the passage of the blank page, and the perforation processing unit 26 perforates the page 5.

As described above, the arithmetic processing unit 40 controls the perforation blade lateral moving unit 25 to be driven during the passage of a page that does not need to be perforated or an inserted blank page.

A process of this embodiment is described next with reference to flowcharts.

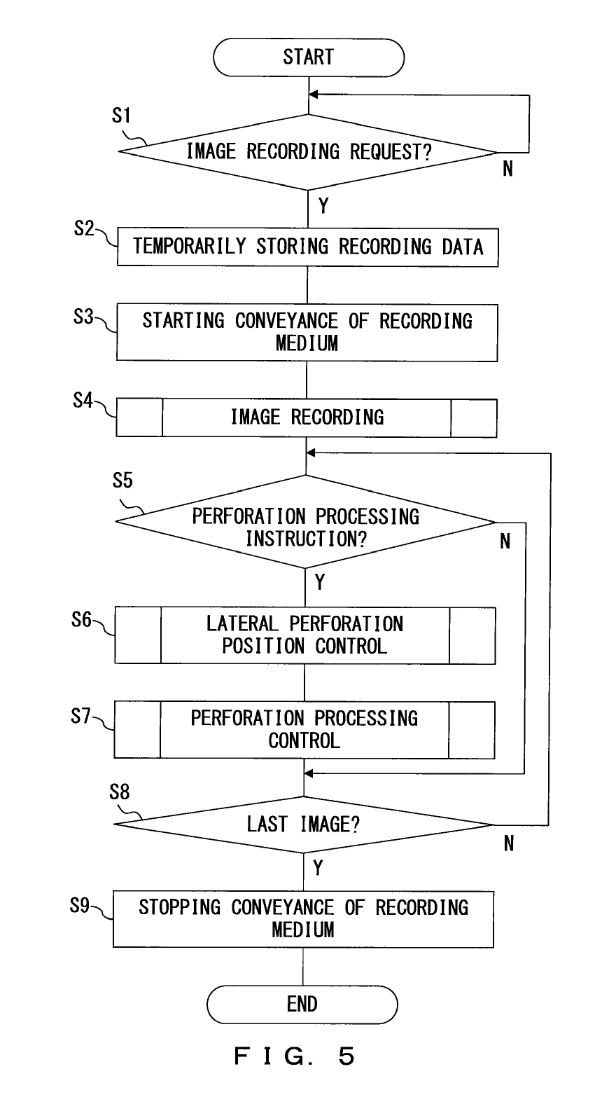

FIGS. 5 to 8 are the flowcharts for explaining a series of printing operations. Initially, the image recording controlling unit 14 determines whether or not an image recording request has been issued from the higher-level device 45 (step (hereinafter abbreviated to S) 1). If the image recording request has been issued from the higher-level device 45 (“YES” in S1), the image recording controlling unit 14 temporarily stores recording data of an image to be recorded, which is provided from the higher-level device 45, in the storing unit 42 (S2).

Next, the image recording controlling unit 14 starts conveying the recording medium 7 (S3). When the conveyance speed of the recording medium 7 reaches a stipulated speed, the image recording controlling unit 14 calls an image recording subroutine to start the image recording process (S4).

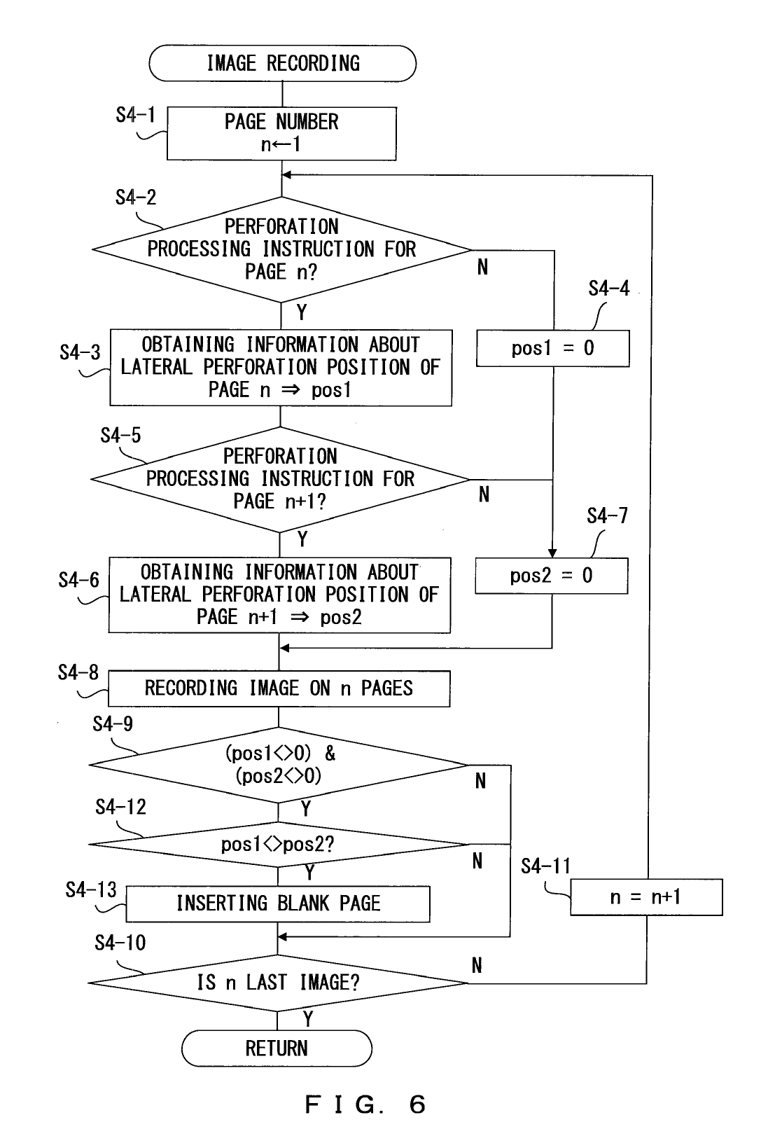

This subroutine is executed according to the flowchart illustrated in FIG. 6. Initially, the arithmetic processing unit 40 sets, to 1, a variable n that indicates a page number (S4-1). Then, the arithmetic processing unit 40 determines whether or not a perforation processing instruction has been issued for the page 1 (S4-2).

This determination is made on the basis of the perforation processing information transmitted from the higher-level device 45 along with the recording data. If the perforation processing instruction has been issued for this page (“YES” in S4-2), the arithmetic processing unit 40 obtains information about the lateral perforation position of the page 1, and sets a variable pos1 to this information (S4-3). In the meantime, if the perforation processing instruction has not been issued (“NO” in S4-2), the arithmetic processing unit 4 sets the variable pos1 to 0 (S4-4).

Next, the arithmetic processing unit 40 determines whether or not the perforation processing instruction has been issued for the next page (page n+1) (S4-5). Similar to the above described determination, this determination is made on the basis of the perforation processing information transmitted from the higher-level device 45 along with the recording data.

Here, if the perforation processing instruction has been issued for the page n+1 (page 2) (“YES” in S4-5), the arithmetic processing unit 40 obtains information about the lateral perforation position of the page 2, and sets a variable pos2 to this information (S4-6). In the meantime, if the perforation processing instruction has not been issued (“NO” in S4-5), the arithmetic processing unit 40 sets the variable pos2 to 0 (S4-7).

Then, the arithmetic processing unit 40 executes the image recording process for n pages (pages 1 and 2) (S4-8). Specifically, the arithmetic processing unit 40 instructs the image recording controlling unit 14 of the image recording process, and the image recording controlling unit 14 instructs the first image recording unit 10-1 and the nth image recording unit 10-n to perform the image recording.

Next, the arithmetic processing unit 40 reads the information about the variables pos1 and pos2, and initially determines whether or not both of the variable pos1 and pos2 are 0 (S4-9). If both of the variables pos1 and pos2 are 0 (“NO” in S4-9), there is no need of perforation. Therefore, the arithmetic processing unit 40 determines whether or not the nth page is the last page of a job (S4-10). If n is not the last page of the job (“NO” in S4-10), the process is continued, and the value of n is updated (n=n+1, S4-11).

In the meantime, if none of the variables pos1 and pos2 are 0 (“YES” in S4-9), this means that the perforation processing instruction has been issued for both the page n and the page n+1 (the page 1 and the page 2) (S4-12). Here, if the variables pos1 and pos2 are equal, the lateral perforation position of the page n and that of the page n+1 are the same. Accordingly, there is no need to change the lateral perforation position.

In the meantime, if the variables pos1 and pos2 are not equal, this means that the lateral perforation position of the page n and that of the page n+1 are different. Accordingly, it is determined that a blank page needs to be inserted (S4-13). Therefore, in this case, the arithmetic processing unit 40 issues an instruction to insert a blank page, and then determines whether or not n is the last image (S4-10). If n is not the last image (“NO” in S4-10), the arithmetic processing unit 40 increments n by 1 (S4-11), and continues the process.

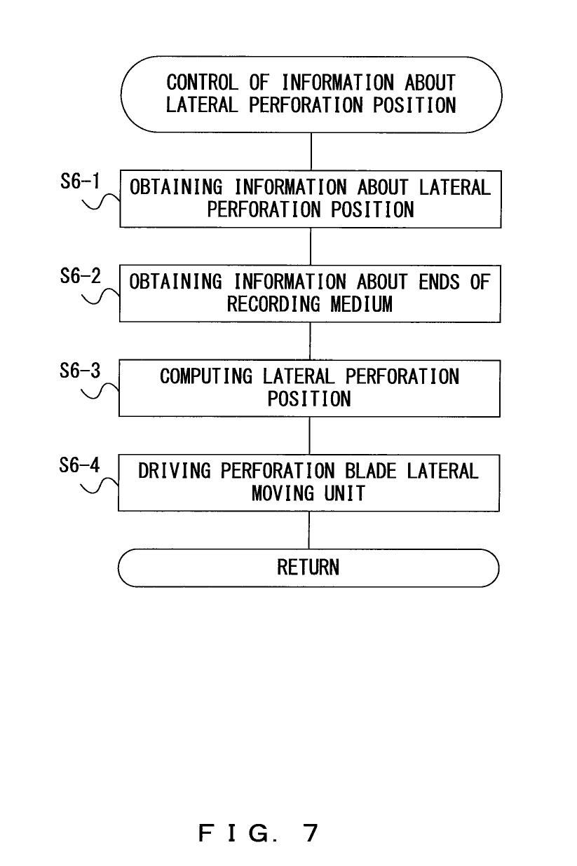

The process is then returned to the flowchart illustrated in FIG. 5. In the above described process, the arithmetic processing unit 40 determines whether or not the current page is a page for which the perforation processing instruction has been issued (S5). If the current page is the page for which the perforation processing instruction has been issued (“YES” in S5), a lateral perforation position is controlled (S6). Specifically, this control is performed according to the flowchart illustrated in FIG. 7. Initially, the arithmetic processing unit 40 obtains information about the lateral perforation position (S6-1), and further obtains the end position information of the recording medium 7 from the above described recording medium end detection sensor 18 (S6-2).

Next, the arithmetic processing unit 40 notifies the perforation blade controlling unit 13 of the above information. Then, the lateral perforation position computing unit 46 computes the lateral position of the perforation blade 28 on the basis of the above information (S6-3). With this computation process, the lateral perforation position computing unit 46 computes the amount of move of the perforation blade 28 to be 194 mm if it is assumed that the lateral perforation position information from the higher-level device 45 is 197 mm and the end position information detected by the recording medium end detection sensor 18 is −3 mm from the reference position of the recording medium 7 as in the above described example. The perforation blade lateral moving unit 25 moves the perforation blade 28 to a position of 194 mm from the reference position of the recording medium 7 in accordance with this information (S6-4).

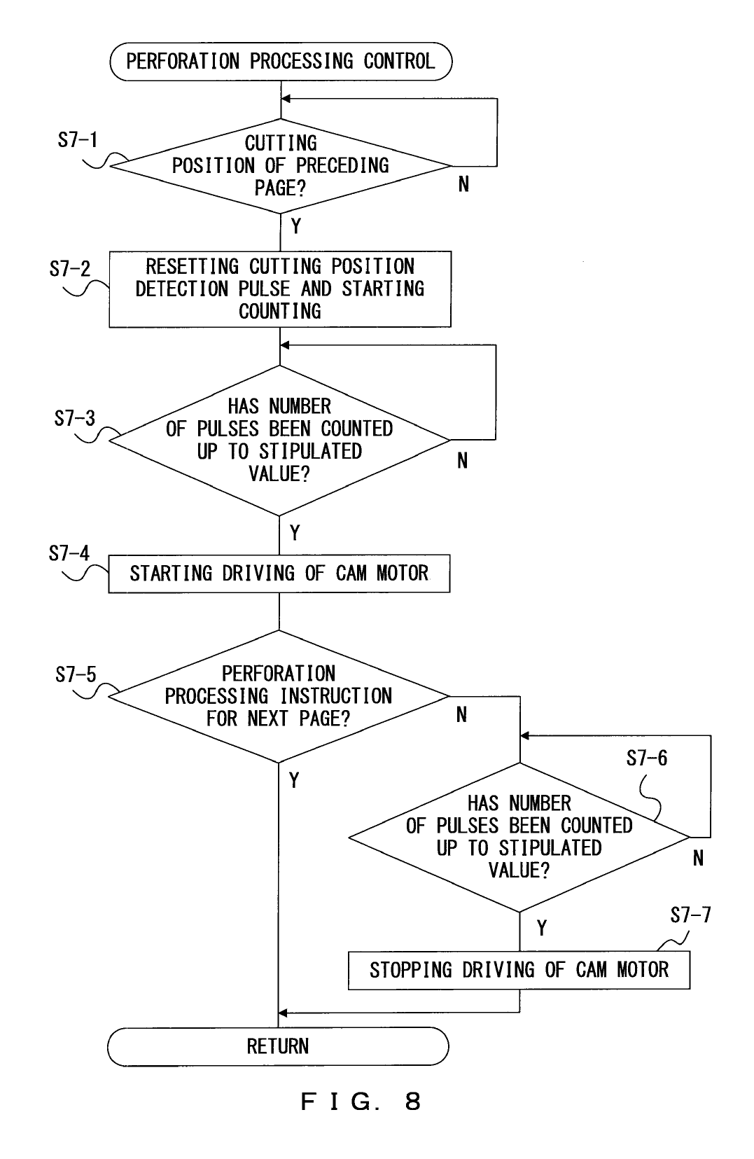

Next, actual perforation processing is performed (S7). Specifically, this processing is performed according to the flowchart illustrated in FIG. 8. Initially, the arithmetic processing unit 40 waits for the process until a page preceding a target page reaches the cutting position (S7-1). When the preceding page reaches the cutting position, the arithmetic processing unit 40 resets the cutting position detection pulse, and instructs the timing generating unit 47 to start counting the pulse (S7-2).

Then, the timing generating unit 47 waits until the number of pulses is counted up to a stipulated value (S7-3). When the number of pulses is counted up to the stipulated value (“YES” in S7-3), the cam motor 29 within the perforation processing unit 26 is driven to perform perforation processing (S7-4).

The cutting position of the recording medium 7 and a perforation processing position are aligned by causing the perforation blade 28 to touch the recording medium 7 at timing when the recording medium 7 is conveyed by 105 mm after being cut if it is assumed that the cutting length of the recording medium 7 in the image recording apparatus 1 is 420 mm as in the above described example. Accordingly, when the cutting origin sensor 34 detects that the recording medium 7 has been cut, the timing generating unit 47 starts counting the pulse of the encoder 36, and a driving instruction is issued to the perforation processing unit 26 so that the perforation blade 28 touches the recording medium 7 at timing when the number of pulses of the encoder 36 is counted up to 2500 at the position where the recording medium 7 is conveyed by 105 mm, and the perforation processing is performed on the recording medium 7 (“YES” in S7-5).

If the perforation processing instruction has not been issued (“NO” in S7-5), the timing generating unit 47 waits until the number of pulses is counted up to a stipulated value (S7-6). After the number of pulses is counted up to the stipulated value, the driving of the cam motor 29 is stopped (S7-7).

Thereafter, it is determined whether or not the current page is the last image (S8). If the current page is the last image (“YES” in S8), the conveyance of the recording medium 7 is stopped, and the entire image recording process is terminated (S9).

As described above, the image recording apparatus 1 according to this embodiment generates perforation processing timing on the basis of the detection information of the cutting origin sensor 34, whereby perforation processing can be performed at desired timing without prerecording a mark or the like on the recording medium 7.

Additionally, the perforation processing can be performed at a desired position by controlling the lateral move of the perforation blade 28 with a motor without making a changeover.

Furthermore, the perforation processing can be performed at a different lateral position without stopping the recording medium 7 by configuring the perforation blade to be movable during the passage of an unperforated page in a direction orthogonal to the recording medium conveyance direction.

A second embodiment according to the present invention is described next.

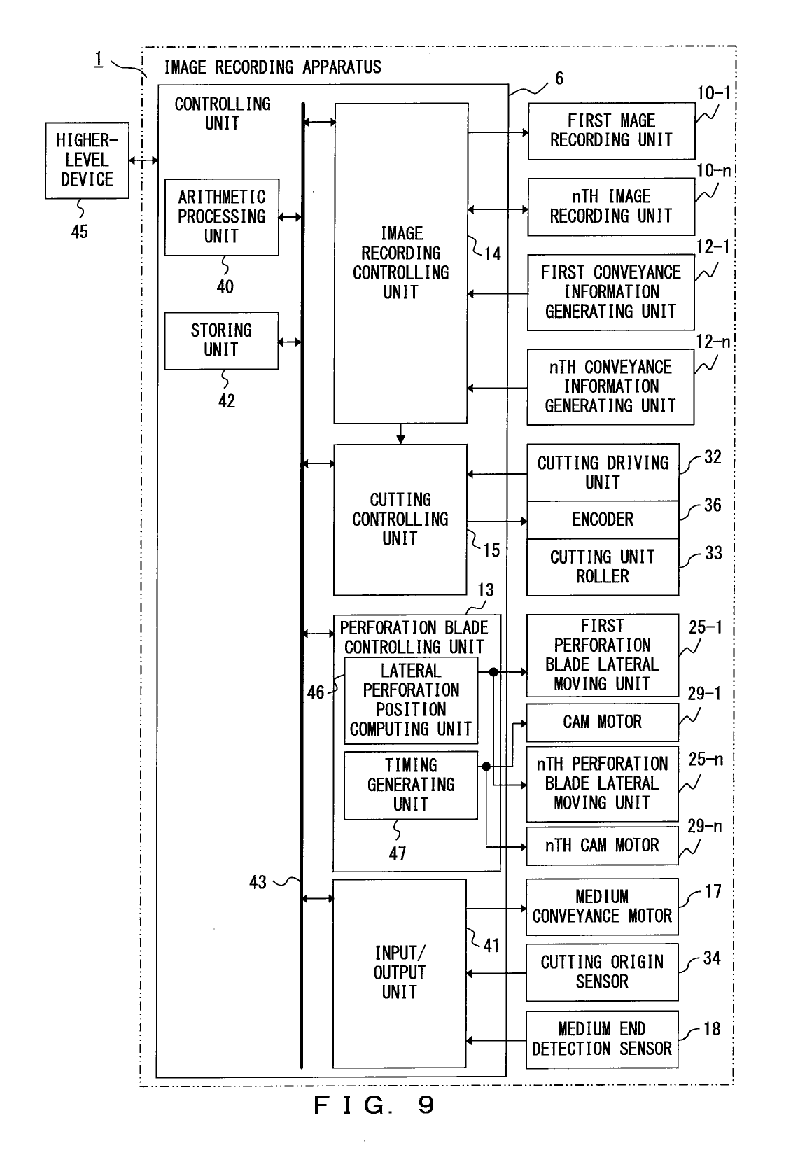

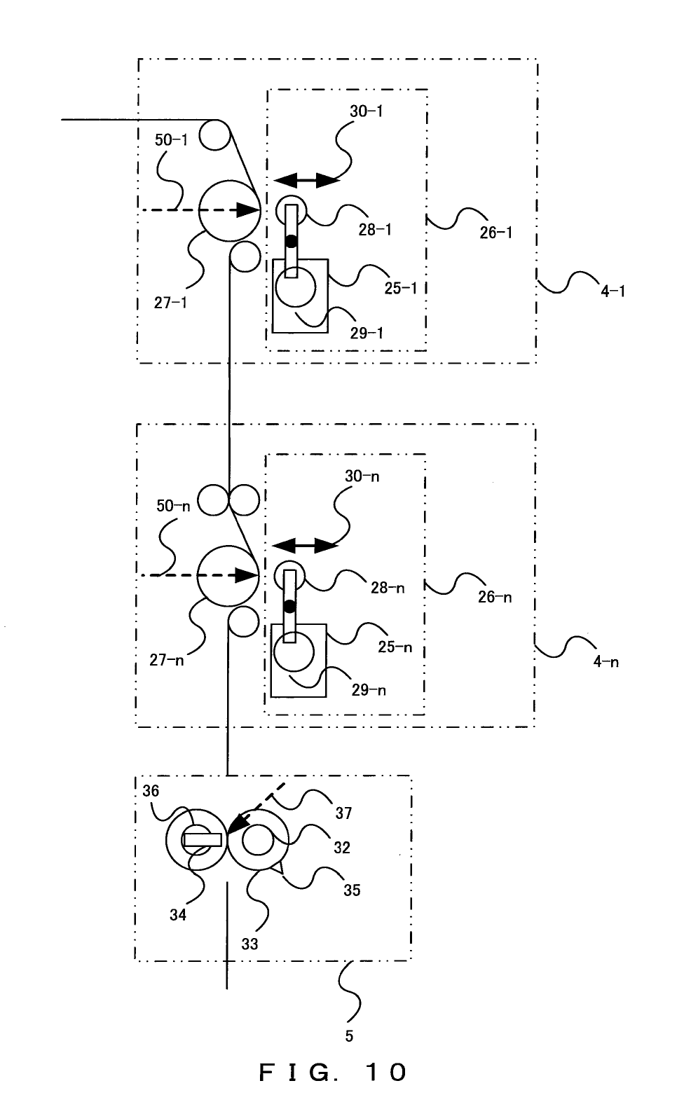

FIG. 9 is a block diagram illustrating a system of the second embodiment. FIG. 10 schematically illustrates a layout of the perforation processing system 4 and the medium cutting system 5 excluding the medium feeding system 2 and the image recording system 3.

The image recording apparatus 1 according to the second embodiment is configured by including a plurality of perforation processing systems 4-1 to 4-n, respectively composed of perforation blade lateral moving units 25-1 to 25-n, and the like. n is an integer equal to or larger than 1.

In this case, the first perforation processing system 4-1 and the second perforation processing system 4-2 perform a control for perforating an odd-numbered page and an even-numbered page, respectively. With such a configuration, the perforation processing systems can be configured not to perforate successive pages but to perforate every other page. Accordingly, there is no need to insert a blank page in the second embodiment unlike the above described first embodiment where a blank page needs to be inserted, whereby perforation processing can be performed at different positions on all pages.

Furthermore, by additionally and sequentially providing perforation processing systems such as a third perforation processing system, a fourth perforation processing system, . . . , perforation processing can be performed at n positions on the same page.

As described above, according to this embodiment, an image recording apparatus having a perforation processing device that can control ON/OFF of perforation processing and can further control a perforation processing position in a direction orthogonal to the conveyance direction of a recording medium on the basis of an instruction issued from a higher-level device can be provided.

The present invention is not limited to the above described embodiments, and can be embodied in a practical phase by modifying components in a scope that does not depart from the gist of the present invention. Moreover, the present invention can be diversified by suitably combining the plurality of components disclosed in the above described embodiments. For example, some components may be deleted from all the components referred to in the embodiments of the present invention.

What is claimed is:

1. An image recording apparatus for recording an image on a recording medium on the basis of printing information from a higher-level device, comprising:
a perforation blade controlling unit for controlling perforation processing on the recording medium on the basis of perforation processing information included in the printing information;
a perforation processing unit for perforating the recording medium on the basis of an instruction of the perforation blade controlling unit; and
a perforation lateral moving unit for moving the perforation processing unit in a direction orthogonal to a conveyance direction of the recording medium on the basis of an instruction of the perforation blade controlling unit.

2. The image recording apparatus according to claim 1, further comprising:
a medium end detection sensor for detecting positions of both ends of the recording medium; and
a lateral perforation position computing unit for computing a perforation processing position on the basis of output information of the medium position detection sensor, and the perforation processing information from the higher-level device.

3. The image recording apparatus according to claim 1, wherein
the perforation blade controlling unit determines a perforation processing position in units of pages on the basis of the information of the higher-level device.

4. The image recording apparatus according to claim 1, wherein
the perforation processing unit can move in the direction orthogonal to the conveyance direction during passage of an unperforated page.

5. The image recording apparatus according to claim 4, wherein
a blank page is inserted if perforation positions of successive pages to be perforated are different, and the perforation processing unit is moved while the blank page is being conveyed.

6. The image recording apparatus according to claim 1, further comprising
a cutting unit for cutting continuous paper as the recording medium, wherein
perforation processing timing is controlled with relative to cutting timing of the cutting unit positioned on a downstream of the conveyance direction of the continuous paper.

7. The image recording apparatus according to claim 1, further comprising
a plurality of perforation processing units, which sequentially perform perforation processing, are included, so that perforation processing can be performed in units of pages even if perforation positions of successive pages are different.

8. A controlling method of an image recording apparatus for recording an image on a recording medium on the basis of printing information from a higher-level device, comprising:
a perforation processing step of perforating the recording medium on the basis of an instruction of a perforation blade controlling unit for controlling perforation processing on the recording medium on the basis of perforation processing information included in the printing information; and
a perforation lateral moving step of moving the perforation processing step in a direction orthogonal to a conveyance direction of the recording medium on the basis of an instruction of the perforation blade controlling unit.

9. The controlling method according to claim 8, wherein
the image recording apparatus further includes a medium end detection sensor for detecting positions of both ends of the recording medium, the method further comprising
a lateral perforation position computing step of computing a perforation processing position on the basis of output information of the medium end detection sensor, and the perforation processing information from the higher-level device.

10. The controlling method according to claim 8, wherein
the perforation blade controlling unit determines a perforation processing position in units of pages on the basis of the information of the higher-level device, and
the perforation processing step can move in the direction orthogonal to the conveyance direction during passage of an unperforated page.

11. The controlling method according to claim 8, wherein
the perforation processing step can move in the direction orthogonal to the conveyance direction during passage of an unperforated page, and
a blank page is inserted if perforation positions of successive pages to be perforated are different, and the perforation processing step is moved while the blank page is being conveyed.

12. The controlling method according to claim 8, wherein
a plurality of perforation processing steps can be executed, and
even if perforation positions of successive pages are different, perforation processing can be performed in units of pages by sequentially executing the plurality of perforation processing steps.
